(19) United States
(12) Patent Application Publication
(10) Pub. No.: US 2009/0211474 A1
(43) Pub. Date: Aug. 27, 2009

(54) PRINTING PRESS INKING SYSTEMS

(76) Inventor: Richard G. Atwater, Rockford, IL (US)

Correspondence Address: VEDDER PRICE P.C., 222 N. LASALLE STREET, CHICAGO, IL, 60601, US

(21) Appl. No.: 12/035,805

(22) Filed: Feb. 22, 2008

(51) Int. Cl. B41K 1/38

(52) U.S. Cl. 101/335

(57) ABSTRACT

An apparatus and method for feeding U.V.-curable inks without causing them to cure prematurely. The apparatus includes plural Moineau style pumps each with an elastomeric stator and a rigid rotor. The pumps are driven by electric motors and flexible drive shafts enabling the stator and rotor to be slight offset from one another. The ink is fed to all of the pumps at the same time from a single trough with baffles therein.

### BACKGROUND OF THE INVENTION

The present invention relates to apparatus and method for feeding a certain class of inks, namely, those which are cured by exposure to Ultra Violet (UV) light, to printing equiment. More particularly, the invention is directed to a method involving using a plurality of so-called progressive cavity apparatus containing plural motors for driving the rotors in a plurality of stator apparatus. In the past, it was not possible to feed U.V. curable inks through the usaual ink feeding apparatus, because the inks would cure or “set up” almost immediately during the feeding process. Hence, in the past U.V.-cured inks simply were never used with existing equipment.

In the printing business, for example, a typical web printing press may include 4, 8 or even up to 24 ink pumps, for example, which supply the printing ink to plural zones or columns across the width of the paper being printed. The ink pumps of these prior designs used a piston that rotated and reciprocated inside a ported sleeve, and in this manner pushed the ink through the ported sleeve. With the present invention, no reciprocating or rotating pistons are used.

Here, a plurality of specially designed stators and rotors are used, and each stator and rotor supplies the ink to one zone or column of printing. There, depending on the layout, each rotor-stator pair works independently of any of the other pairs. This means that the ink pumps must ordinarily be closely spaced apart from one another. This is because the space taken up by the ink pumps cannot exceed the width of the printing unit. Also, because the requirements for printing mean that any one zone may have the same, similar, or quite different ink requirements than any other zone, the ink pump system must be able to accommodate each of these different requirements. This was done in one case in the prior art by varying the speed of each individual pump, thus varying the amount of ink pumped depending on the requirements of that column.

According to the present invention, instead of the piston and sleeve arrangement, the system uses an array of the plural rotor-stator systems of a so-called progressive cavity type. In this system plural eccentric worm rotors working within the respective stators pump individual portions of ink as required to the printing press. For example, these pumps are of the so-called Moineau or progressive cavity type. They use a wormlike rotor which rotates inside a stator having a particularly designed configuration. Such pumps are described in U.S. Pat. No. 6,155,807, issued Dec. 5, 2000 and U.S. Pat. No. 5,472,319, issued Dec. 5, 1995, among many others. The contents of both of these patents are hereby incorporated by reference fully herein, and illustrate the Moineau style pumps.

According to the instant method, among the unique factors is the way in which these U.V.-cured, usually thixotropic, inks are pumped. U.V.-cured inks cannot be fed or pumped satisfactorily by any other type of pump, because the inks “set up” almost instantly if processed by the usual pumps. The pumps of the invention have so-called progressive cavities formed in a particular shape, from an elastomeric material for the stator, and stainless steel for the rotor, for example. The rotor is characterized as having a single helix pattern and the stator has a double helix pattern, thus accounting for the progressive cavities, as the rotor gyrates within the stators.

The novel features of the present invention include the manner in which ink is fed to and from each of these progressive cavity pumps, and, in general, the apparatus for controlling the paths followed by such ink. In some embodiments, there is a high frequency, (e.g., 200-800 cycles per minute) low amplitude, intermittent motion of the motors. In other embodiments, there is a low amplitude continuous motion. The different mechanisms all include worm-like single helix rotors and double helix elastomeric stators of appropriate shapes.

It is therefore an object of the present invention to provide an array of individual Moineau-style pumps spaced closely apart, but independent of one another, to pump a large quantity of U.V.-curable ink toward a multi-column press or other application.

A further object of the invention is to provide a separate drive for each of plural U.V-curable ink pumps.

Another object is to provide a pair of novel systems and arrangements for driving eccentric rotary ink pumps with U.V.-cured inks.

A still further object of the invention is to provide a plurality of similar pump drive mechanisms, wherein an intermittent rotary motion is provided in one direction for the rotor which pump the U.V.-cured ink.

Another object is to provide an apparatus in which a large quantity of U.V.-cured ink can be placed in an open feeder trough, that is, having baffles subdividing the interior, but having an open bottom for delivery of the ink to the pumps.

It is also an object of the invention to create a pump system for U.V.-cured inks which use certain classes of materials, namely, a synthetic rubber stator such as Buna-N rubber or vinyl nitride. The rotor may be made from a non-ferrous metal such as stainless steel, or from aluminum, ceramics, or a suitable plastic such as nylon, Kynar or PVDF. Other suitable materials will be known to those skilled in the art.

Another object of the invention is to provide a progressive cavity apparatus for advancing U.V.-cured inks along a certain path.

A still further object is to provide an apparatus in which there is a metal worm and a synthetic rubber stator, and the rotor rotates within the stator along a slightly offset path, thereby moving the U.V.-curable ink in a series of progressive cavities.

Another object is to provide one or more novel systems and arrangements for driving eccentric rotary ink pumps capable of processing U.V-curable inks.

Another object of the invention is to provide a progressive cavity apparatus for advancing U.V-curable ink along a predetermined path.

A still further object is to provide an apparatus in which there is a stainless steel worm type rotor and a Buna-N stator, wherein the worm rotates within the stator along a slightly offset path, thereby moving the ink in a series of progressive cavities.

Another object is to keep the highly viscous, thixotropic inks from accumulating excessively at one side of the trough in response to the rotary motion of the rotor.

### SUMMARY OF THE INVENTION

The invention achieves these and other objects by creating a single, unitary apparatus and method which includes using a plurality of single helix, worm-like rotors gyrating inside a plurality of elastomeric double helix passages, a trough for receiving a large quantity of U.V.-cured inks and delivering individual portions of ink to a plurality of separate columns for a printing press.

The exact manner in which these objects and other objects and advantages are achieved in practice will become more apparent when considered in conjunction with the following detailed description of the invention and shown in the accompanying drawings in which like reference numbers indicate corresponding parts throughout.

### BRIEF DESCRIPTION OF THE DRAWINGS

FIG. 1 is a perspective view of several ink pumps wherein there is a single so-called stepper motor for each pump, operating through a toothed belt to drive a shaft for each pump, and showing plural hoppers for receiving, in this case, an U.V.-cured ink, with the various ink pump inlets being at the bottom of the trough and the outlets for the ink in individual hoses at the lowest part of the apparatus;

FIG. 2 is a vertical sectional view of the ink pump apparatus of FIG. 1;

FIGS. 3-3A are a perspective views of the drive train of FIGS. 1 and 2;

FIG. 4 is a greatly enlarged side elevational view of the rotor, showing its single helix configurations; and

FIGS. 4A-4D show the cross-section of the eccentric rotor at the various positions of the rotor inside the cylindrical elastomeric stator; and the ink in the progressive cavities of the invention.

FIG. 5 is a greatly enlarged vertical sectional view of the rotor and stator, and showing the sideways movement of the rotor and the spaced apart pockets for advancing the ink, as well as showing the two axes very closely spaced apart.

While changes and variations may be made to the apparatus and method by those skilled in the art, the described method and apparatus are presently preferred by the inventors herein.

### DESCRIPTION OF PREFERRED EMBODIMENTS

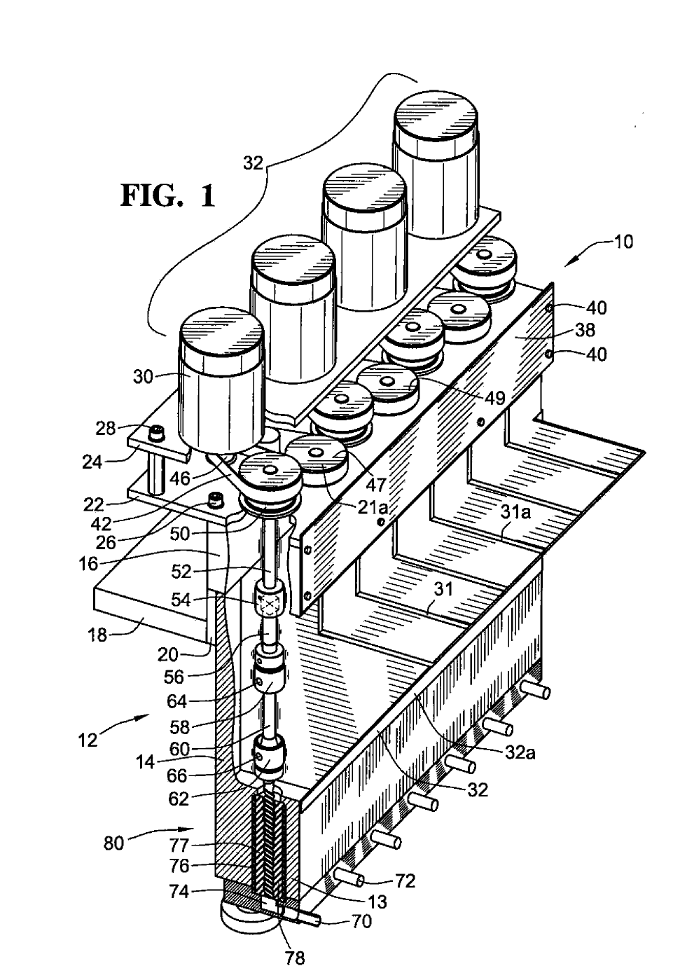

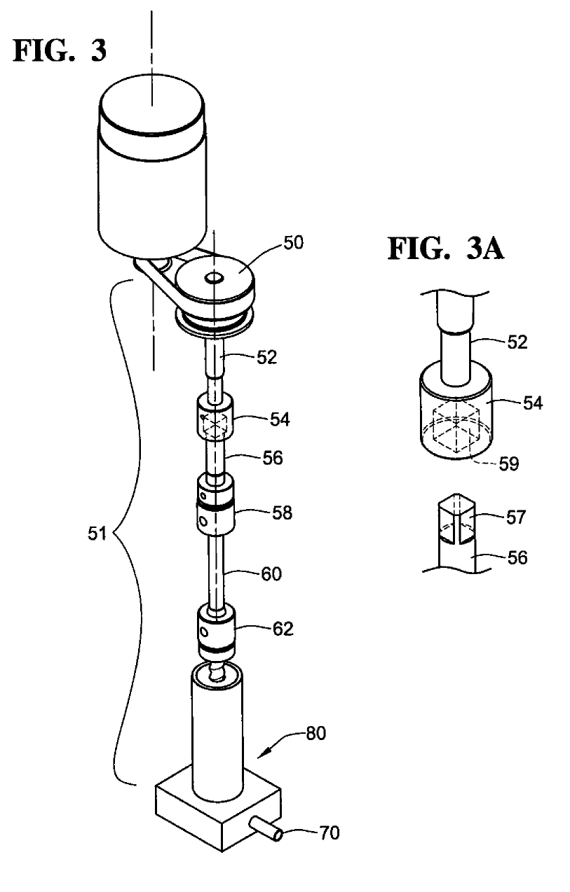

Referring now to drawings in greater detail, FIGS. 1-3 show the invention to be embodied in an ink pump apparatus for U.V.-curable inks generally designated 10, which includes a frame generally designated 12 having a horizontally extending portion 13 and a vertically extending portion 14. There is also an extension 16 of the vertical portion of the frame 12 and affixed thereto; the extension 16 completes the vertical portion of the frame 14. The frame 12 further includes a horizontal shelf 18 extending outwardly from the frame 14. In addition to this shelf, there are an additional pair of shelves, a lower shelf 22 and an upper shelf 24, with fasteners 26, 28 adapted to securely position these shelves relative to the frame 12.

There is one motor 30 shown which will be described in some detail. The motor 30 is one of an array of four upper motors generally designated 32 which are identical to the motor 30. The motors 30 are secured to the shelf 24, and operate the small pulleys 46 shown, and serve as the primary drive for the shafts, as will be explained. In other words, the smaller pulley 46 rotates faster than the large pulley 50, giving the larger pulley a slower rotational velocity, but a much larger force.

The frame 14 is covered in its upper portions by a plate 38, which is held in place by fasteners 40.

The motor 30, and each of the other motors are substantially identical thereto, includes a shaft terminating in a reduced size pulley 46 which in turn drives a toothed belt 42.

The belt 42 is trained around a larger pulley 50. The relative sizes of the pulleys 46, 50 establish the mechanical advantage of this drive, in this case 3 to 1. Any other drive can be used, however, the smaller pulley 46 rotates faster than the large pulley 50, giving the large pulley a slower rotational velocity, but a much larger force.

The pulley forms the top portion of a power train 51 which begins with an upper drive shaft 52. This uppermost drive shaft 52 terminates at its bottom in an upper coupler 54 with a re-entrant in the bottom surface. There is an intermediate shaft 56 lying between the upper coupler 54 and the top portion of the upper universal joint 58. The upper universal joint 58 has a third shaft 60 extending toward and joining the lower universal joint 62.

These universal joints 58, 62 enable the rotor to accommodate its off-center action to be described herein. There are pins 64, 66 forming one part of each universal joint 58, 62 to allow motion in that plane.

There are a plurality of ink outlets 70, 72, etc. in the form of tubes or hoses to receive the U.V-curable ink, as will be explained further herein. The lower portion of the frame element 13 includes a plurality of hollow chambers 74, etc., each one of which communicates with a corresponding lower hose connector 70, 72, etc. In other words, the chambers 74, etc. are isolated from one another.

An incidental feature of the drive train is in the construction of the upper connector 54. This hollow coupler 54 is adapted to receive a square end portion 57 of the intermediate shaft 56 in an opening 59; a square opening 59 has been shown, but any non-circular opening will function. This enables the user to separate the power train for maintenance, etc.

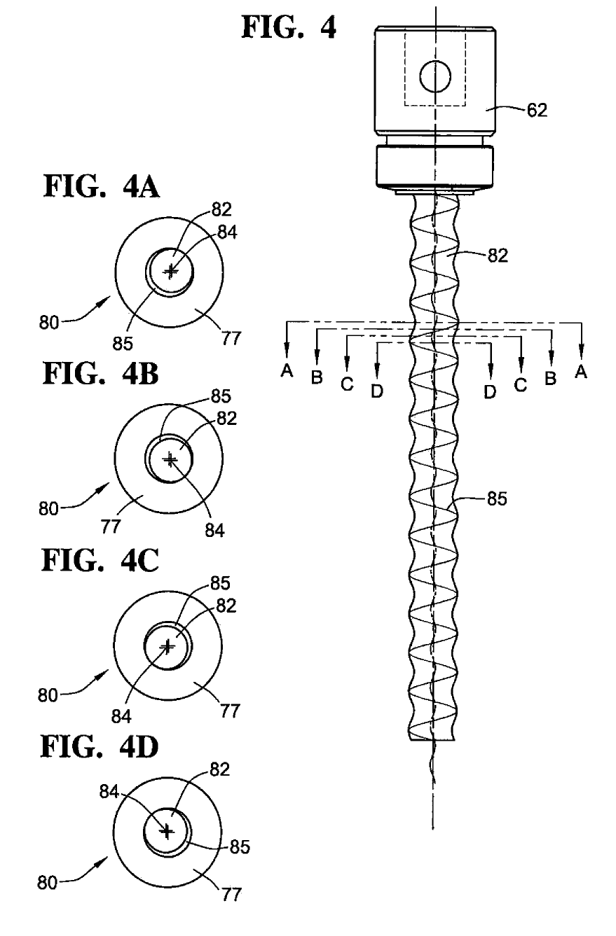

Referring now to FIGS. 4-4D, there is shown a view of the rotor 82 which is affixed to the lower universal joint 62 and extends downwardly therefrom. The rotor 82 has a tight fit in the rubber core of the stator 80. From FIG. 4, the single helix construction of the rotor 82 can be seen. The sine wave of the drawing FIG. 4 shows the highest points 85 of the single helix. The body of the rotor 82 will be seen by reference to FIGS. 4A-4D. These drawings illustrate the section of the progressive cavities or pockets 90, 92 as they progress along the interior of the stator 77. These cavities are depicted in lines A-A, B-B, C-C and D-D. The two offset axes can also be seen as the double crosses 84, one being the center of the rotor and the other being the axis about which the rotor travels.

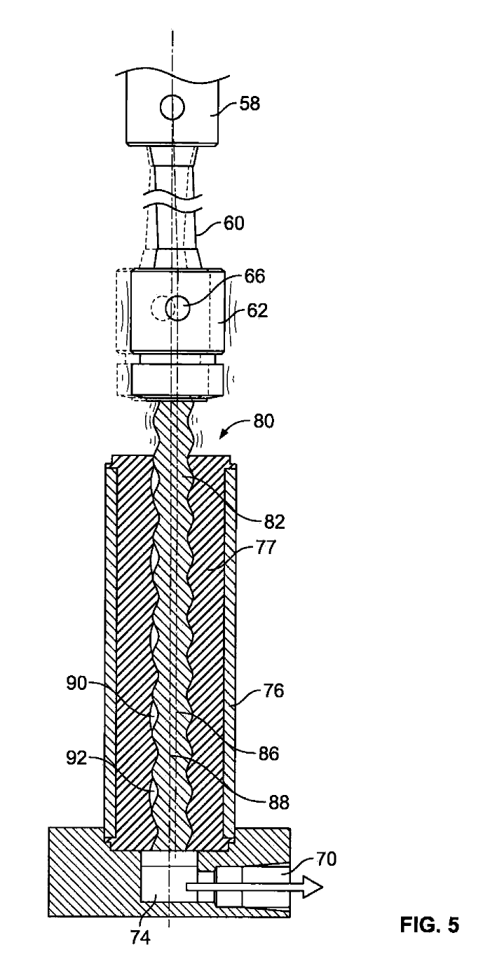

Referring now to FIG. 5 there is shown the stator generally designated 80, and the two axes are illustrated in the broken lines 86 and 88. These show the geometric center and the center of rotation of the rotor in use.

Another illustration is shown in FIG. 5 where the progressive cavities or pockets 90, 92 are formed by the double helix characterizing the stator and the single helix characterizing the rotor 85. These cavities move along toward the outlets of the stators as the rotor 85 revolves or gyrates.

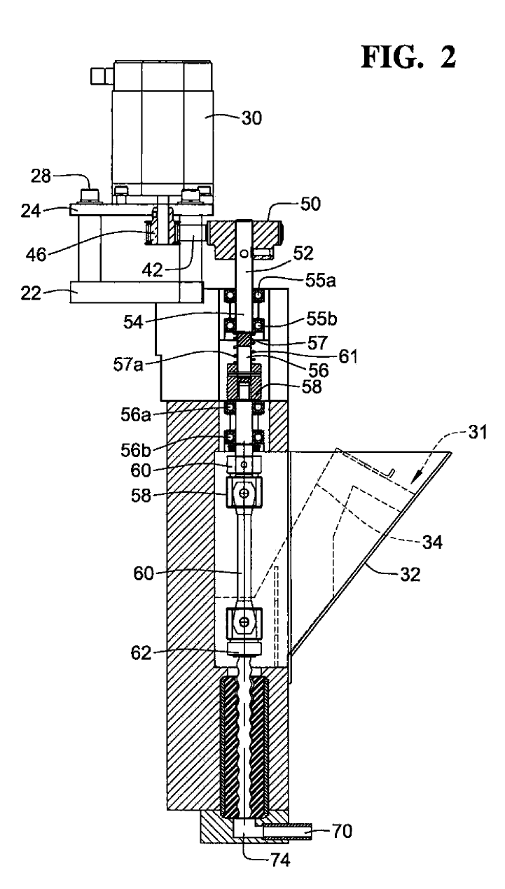

Referring now to the operation and use of the device and method of the invention, it is assumed that the ink will be placed in a single large volume trough 30 with a plurality of the baffles or interior or walls 31, 31a, etc., subdividing the trough 30 at the top, but with the lower portions of the walls or baffles being spaced from the bottom of the trough. The inclined inner walls 34 shown in phantom lines in FIG. 2, urge the upper portions of the viscous thixotropic ink to the baffles, and these baffles are shown in FIGS. 1 and 2. The baffles prevent the ink from accumulating at the right hand side of the pump (facing the pumps).

The motors are activated, each with its own speed control, with the result that the small pulleys 46 pull the belt 42 around the upper or larger pulleys 50. This causes the various shafts 52, 56, 60 to rotate each one with its own speed. The speed at which the drive shafts rotate can vary considerably. Thus, with a stepper motor, there are some 200-400 steps in one revolution. There are some motors available which would have up to 800 steps per revolution. Thus, if one is using a stepper motor in the apparatus, the signal advances the motor in that way.

The shafts 52, 56, 60 described are shown to be supported by, or run in appropriate bearings 55A, 55B, etc. as well as bearings 56A and 56B. These ensure that the drive shafts will rotate as desired, with there being virtually no departure from a true circular course. The spring 57A keeps the shaft 52 and the shaft 56 in close proximity with the square portion 57 of the shaft end 57 fitting into the square recess 59.

Therefore these drive shafts should all function satisfactorily, but if it comes time to remove the lower portion of the apparatus from the upper portion, one merely needs to slide down the springs 57A and the locking part 57 may readily be removed merely by hand pressure.

As the drive shaft rotates, and the two universal Joints 58, 62 rotate on their respective axes, ink is taken from the lower portion of the trough 32 surrounding the lower universal joint 62. With this universal joint 62 and the rotor 82 rotating, and with the stator 80 standing still, there is a progressive movement of the cavities or pockets, as they are advanced by the action of the rotor 82. The action of the pump thus immediately fills and maintains under pressure the now ink-filled chamber 74, located just beneath the lower end of the stator 80.

In the illustrated case, the motors that are not shown operate the pulleys 47, 49, etc., and these operate adjacent and parallel drive trains to those energized by the motors 30, 32, etc. Each of these pumps is operated by entirely separate signals, with the motors being allowed to operate completely independently of the other.

In another embodiment, the motors are operated by strictly a direct, non-digital operation, and these motors can be operated in this way if desired.

Referring now to the materials from which the various components are made, most non-ferrous metals can be used, but ferrous materials cannot be used, with the exception of stainless steel. Aluminum, a variety of ceramics and very hard plastics such as a Kynar, PVDF and nylon can be used. The main requirement is that the rotor be strong enough to hold up under the strain of being in contact with the relatively stiff stator as it engages the rubber.

Referring now to the rubbers, the most important factor is to ensure the rubber has a high enough Durometer, about 90 to 95, in order to function. The rotor is strongly resistant to rotation when there is an initial tight fit between the rotor and the stator, but as the rotor continue to rotate, it becomes somewhat more compliant. The main consideration for the rubber is that it has a high enough Durometer (90-95, for example). Other stiff rubbers besides a Buna-N includes for example, some vinyl nitrides, which are commercially available.

It will thus be seen that the present invention provides an apparatus and method for feeding U.V.-curable inks to their destination without premature curing. The apparatus includes a number of individual worm and stator type pumps, and means for driving the rotor around the stator at the correct rate. Further embodiments of the invention having been described in detail, and other changes in modifications may be made to the described form of apparatus and method, and it is anticipated that such changes or modifications may be made without departing from the spirit of the invention of the scope of the appended claims.

1. An apparatus for feeding U.V. curable inks to a plurality of spaced apart means, said means each terminating adjacent the various printing units of a printing press without allowing said inks to cure prematurely, said apparatus comprising, in combination, a frame adapted to hold a plurality of individual ink pumps of the worm and stator type, said pumps being in closely spaced relation, plural individual stators each made from a cylinder of elastomeric material, each of said stators having an opening therein for receiving a single helix rotor, a double helix stator, a rotor for an eccentric worm style pump, said rotors being positionable within said double helix stators, plural drive shafts, one for each rotor, and flexible means for each drive shaft permitting each drive shaft to swing through a small arc, plural motors operationally connected to one of said flexible drive shafts, liquid-tight means for receiving said mass of U.V. curable inks and feeding such inks to each of said rotor-stator pairs, the rotational axis of each of said rotors being very slightly offset from the respective centers of said stators, whereby said ink is fed to said various ink outlets at rates determined by the respective rotational velocities of said rotors.

2. An apparatus as defined in claim 1 wherein said spaced apart means comprise hoses leading from the outlets of said pumps to printing units.

3. An apparatus as defined in claim 1 wherein said elastomeric material is a synthetic rubber.

4. An apparatus as defined in claim 1 wherein said elastomeric material is a Buna-N rubber.

5. An apparatus as defined in claim 1 wherein said rotors are made of stainless steel.

6. An apparatus as defined in claim 1 wherein said rotors have a slight interference fit with the stators.

7. An apparatus as defined in claim 1 wherein said flexible means comprises two universal joints for each drive shaft.

8. An apparatus as defined in claim 1 wherein said means for receiving said U.V.-curable inks comprises a single trough having plural baffles therein, each being spaced apart from the bottom of said trough, the lower portions of said baffles, said trough being adjacent the inlets of said pumps.

9. An apparatus as defined in claim 1, wherein said elastomeric material is encased in a metal shell.

10. An apparatus as defined in claim 1 wherein said means for receiving said U.V. curable ink is a single trough, with plural baffles therein, each spaced from the bottom of the trough, said baffles preventing said ink from accumulating in adjacent hoppers.

11. An apparatus for feeding U.V. curable inks to a plurality of spaced apart hoses terminating adjacent the various print units of a printing press, without causing said U.V. curable in to cure prematurely, said apparatus comprising, in combination, a frame receiving a plurality of individual ink pumps of the worm and stator type, said pumps lying in a single plane and being in closely spaced relation with one another, plural stators made from cylinders of synthetic rubber and having double helix forms, said rubber having a Durometer reading of at least 90, said stators having openings disposed axially therein for receiving a plurality of single helix rotors, plural single helix rotors, plural motors and plural drive shafts, one for each rotor and two universal joints for each drive shaft, thereby permitting each drive shaft to swing through a small arc, a single liquid-tight hopper for supplying ink to said stators and feeding such ink to each of said stators, whereby the amount of ink pumped from any one pair of rotor-stators is totally independent of any amount of ink from any other rotor-stator pair.

12. A method of feeding U.V.-curable inks to an outlet without causing said inks to cure prematurely, said method comprising feeding individual portions of said inks to a plurality of pumps of the worm and stator type, said stators being of the double helix type and said rotors being of the single helix type, said pumps comprising said pumps being in closely spaced relation, selecting plural individual double helix stators each made from a cylinder of elastomeric material, and each having an opening therein for receiving a motor-driven single helix rotor, said rotors also fitting into said stators, said motors being operationally connected to flexible means on each of said drive shafts, said drive shafts being connected to said rotors, and said outlet receiving said U.V. curable inks and feeding said inks to a press from a position adjacent the pump outlets at a rate determined by the rotational velocity of said rotors.

13. A method of feeding U.V.-curable inks to an outlet without causing said inks to cure prematurely, said method comprising providing a plurality of pumps of the worm and stator type, said stators being made of elastomeric material and being of the double helix type, and said rotors being made of a relatively rigid material and being of the single helix type, said pumps being in closely spaced relation, and plural motors operationally connected to flexible means on each of a plurality of drive shafts, said drive shafts being operationally connected to said rotors, feeding a mass of ink to the inlets of plural ink pumps, and taking said ink from each of said ink pumps and supplying it to a plurality of separate outlets each connected to a printing unit, said ink being fed at a rate determined by the respective rotational velocity of said rotors.

14. A method as defined in claim 13 wherein said pumps are arrayed in a single plane.

15. A method as defined in claim 13 wherein said relatively rigid material is stainless steel.

16. A method as defined in claim 13 wherein said elastomeric material is a Buna-N material.

17. A method as defined in claim 13 wherein elastomeric material has a Durometer of about 90-95.

18. A method as defined in claim 13 wherein said flexible means comprises two universal joints for each drive shaft.

19. A method as defined in claim 13 wherein said relatively rigid material is one or more of the group of materials comprising non-ferrous metals, ceramic materials, aluminum, rigid plastic, Kynar, nylon and PVDF.

20. A method as defined in claim 13 wherein said rotor and said stator have at least an interference fit with each other.
